(19) United States
(12) Patent Application Publication
(10) Pub. No.: US 2023/0164843 A1
(43) Pub. Date: May 25, 2023

(54) HANDLING SCELL DEACTIVATION FOR UNLICENSED OPERATION

(71) Applicant: Telefonaktiebolaget LM Ericsson (publ), Stockholm (SE)

(72) Inventors: Min WANG, Luleå (SE); Iana SIOMINA, Täby (SE)

(21) Appl. No.: 17/919,382

(22) PCT Filed: Apr. 20, 2021
(86) PCT No.: PCT/SE2021/050360

§ 371 Date: Oct. 17, 2022

Related U.S. Application Data
(60) Provisional application No. 63/012,707, filed on Apr. 20, 2020.

(51) Int. Cl. H04W 74/08

(52) U.S. Cl. CPC H04W 74/0816; H04W 74/0866

(57) ABSTRACT

A method, system and apparatus are disclosed. In one or more embodiments, a wireless device is provided. The wireless device includes processing circuitry configured to: perform a listen before talk, LBT, recovery procedure based at least on one of expiration and triggering of a first timer where the first timer is associated with a LBT failure criterion that is met for at least a first bandwidth part, BWP, associated with a first secondary cell, SCell. The LBT recovery procedure includes one of: switching to a second BWP associated with the first SCell for LBT recovery where the second BWP does not meet the LBT failure criterion, and selecting a second SCell for LBT recovery.

### FIELD

The present disclosure relates to wireless communications, and in particular, one or more listen before talk (LBT) procedures such as those procedures/actions based on a LBT failure criterion being met for at least one bandwidth part (BWP).

### BACKGROUND

New Radio (NR, Also Referred to as 5^{th} Generation (5G)) in Unlicensed Spectrum (NR-U)

As the 5th generation of cellular system, called New Radio (NR), is being standardized in Third Generation Partnership Project (3GPP). NR is being developed at least in part for maximum flexibility to support multiple and substantially different use cases. For example, besides the typical mobile broadband use case, NR is being developed to also handle machine type communication (MTC), ultra-low latency critical communications (URLCC), side-link device-to-device (D2D) and several other use cases too.

In NR, the basic scheduling unit is referred to as a “slot.” A slot has 14 Orthogonal frequency-division multiplexing (OFDM) symbols for the normal cyclic prefix configuration. NR supports many different subcarrier spacing configurations and, at a subcarrier spacing of 30 kHz, the OFDM symbol duration is ˜33 us. As an example, a slot with 14 symbols for the same subcarrier-spacing (SCS) is 500 us long (including cyclic prefixes (CPs)).

NR also supports flexible bandwidth configurations for different wireless devices (WDs) on the same serving cell. In other words, the bandwidth monitored by a wireless device (i.e., user equipment (UE)) and used for its control and data channels may be smaller than the carrier bandwidth. One or multiple bandwidth part configurations for each component carrier can be semi-statically signaled to a wireless device, where a bandwidth part consists of a group of contiguous physical resource blocks (PRBs). Reserved resources can be configured within the bandwidth part. The bandwidth of a bandwidth part may be equal to or smaller than the maximal bandwidth capability supported by a wireless device.

NR targets both licensed and unlicensed bands and a work item named “NR-based Access to Unlicensed Spectrum (NR-U)” was initiated in January 2019. Allowing unlicensed networks such as networks that operate in shared spectrum (or unlicensed spectrum) to effectively use the available spectrum is an attractive approach to increase system capacity. Although unlicensed spectrum does not match the qualities of the licensed regime, solutions that allow for an efficient use of the unlicensed spectrum as a complement to licensed deployments have the potential to bring added value to 3GPP network operators, and, ultimately, to the 3GPP industry as a whole. It is expected that some features in NR may need to be adapted to comply with the special characteristics of the unlicensed band as well as also different regulations. A subcarrier spacing of 15 or 30 kHz are possible candidates for NR-U OFDM numerologies for frequencies below 6 GHz

When operating in the unlicensed spectrum, one or more regions in the world may require a wireless device to sense that the wireless communication medium as free before transmitting, which is an operation that is referred to as listen before talk (LBT). There are several different versions of LBT, depending on which radio technology the wireless device uses and which type of data the wireless device wants to transmit at the moment. Common for all versions is that the sensing/LBT is performed in a particular channel (corresponding to a defined carrier frequency) and over a predefined bandwidth. For example, in the 5 GHz band, the sensing is performed over 20 MHz channels.

Many wireless devices are capable of transmitting (and receiving) over a wide bandwidth including multiple sub-bands/channels, e.g., LBT sub-band (i.e., the frequency part with bandwidth equals to LBT bandwidth). A wireless device may only be allowed to transmit on the sub-bands where the medium is sensed as free. Again, there are different versions of how the sensing should be performed when multiple sub-bands are involved.

In principle, there are two ways a wireless device can operate over multiple sub-bands. One way is that the transmitter/receiver bandwidth is changed depending on which sub-bands were sensed as free according to the LBT procedure. In this setup, there is only one component carrier (CC) and the multiple sub-bands are treated as a single channel with a larger bandwidth. The other way is that the wireless device operates almost independent processing chains for each channel. Depending on how independent the processing chains are, this option can be referred to as either carrier aggregation (CA) or dual connectivity (DC).

Channel Access Procedure in NR Unlicensed Spectrum

Listen-before-talk (LBT) is designed for unlicensed spectrum co-existence with other radio access technologies (RATs). In this mechanism, a radio device (e.g., wireless device, network node) applies a clear channel assessment (CCA) check (i.e., channel sensing) before any transmission. The radio device that wants to transmit performs energy detection (ED) over a time period and compares the ED over a time period to a certain threshold (ED threshold) in order to determine if a channel is idle. In case the channel is determined to be occupied, the radio device that wants to perform transmission performs a random back-off within a contention window before next CCA attempt. In order to protect the acknowledgment (ACK) transmissions, the radio device (transmitter) may defer a period after each busy CCA slot prior to resuming back-off. As soon as the radio device (transmitter) has grasped access to a channel, the transmitter is only allowed to perform transmission up to a maximum time duration (namely, the maximum channel occupancy time (MCOT)). For quality of service (QoS) differentiation, a channel access priority based on the service type has been defined. For example, there are four LBT priority classes that are defined for differentiation of contention window sizes (CWS) and MCOT between services.

Prior to any transmission in the uplink, the wireless device may need to perform the LBT operation to grasp the channel, i.e., whether the channel is occupied or in use. For instance, the medium access control (MAC) layer initiates a transmission, the MAC layer requests the physical (PHY) layer to initiate the LBT operation, the PHY layer further sends an indicator to the MAC indicating the LBT outcome (i.e., success or failure).

Radio Link Monitoring in LTE and NR Licensed

One of the intentions of a radio link failure (RLF) procedure in LTE is to assist the wireless device in performing a fast and reliable recovery without having to enter radio resource control idle state (RRC_IDLE). It may be beneficial to avoid unnecessary latency due to the random access channel (RACH) access and RRC connection establishment from RRC_IDLE. An example of radio link monitoring in LTE is illustrated in FIG. 1.

In Long Term Evolution (LTE, also referred to as 4^{th} Generation (4G)), there are several reasons that may lead to the radio link failure, including:

1) Timer T310 expiry

While the wireless device is in RRC connected mode/state, the wireless device monitors the downlink radio channel quality based on the downlink reference symbol. The wireless device compares the measured downlink channel quality with the out-of-sync and in-sync thresholds, Qout and Qin respectively. The physical channel evaluates the downlink channel quality, periodically sends an indication of an out-of-sync or in-sync, to layer 3 (i.e., Open System Interconnection (OSI) layer 3). The wireless device layer 3 then evaluates if the radio link failure based on the in-sync and out-of-sync indications, that output from the layer 3 filter. When the consecutively received out-of-sync indications are beyond the counter N310, a timer T310 is started. While T310 is running or counting down, the radio link may be considered to be recovered if the wireless device consecutively receives N311 in-sync indications from the physical layer.

When the timer T310 is expired, a radio link failure is declared by the wireless device.

2) Maximum number of radio link control (RLC) retransmissions in uplink is reached.

3) Handover failure and timer T304 expiry

During a handover procedure, the timer T304 is started when the wireless device receives a handover command from the source cell where the value of the timer T304 may be set to allow the wireless device to try the maximum RACH access attempts to the target cell. When the timer T304 is expired, a radio link failure due to handover is detected.

When a radio link failure is triggered, the radio connection re-establishment is triggered. A wireless device may first perform a cell search to determine the best cell for radio link re-establishment. According to one or more wireless communication standards such as 3GPP Technical Specification (TS) 36.300 v15.7.0, a wireless device can select the same cell, a different cell from the same network node, or a prepared cell from a different network node, wherein the activity can be resumed (i.e., the wireless device stays in connected mode) via radio connection re-establishment procedure since the previous wireless device context can be retrieved by inter-cell communication. However, when a prepared cell is not available, the wireless device selects an unprepared cell. In this case, the wireless device may have to go to RRC idle mode and try to set up the radio connection afterwards. In this case, activity of the wireless device cannot be resumed. Table 10.1.6-1 (Table 1, below) from 3GPP TS 36.300 may, for example, guide the wireless device behavior for target cell selection.

TABLE 1

| Cases | First Phase | Second Phase | T2 expired |
|---|---|---|---|
| WD (wireless device) | Continue as if | Activity is resumed by means | Go via |
| returns to the same | no radio | of explicit signalling between | RRC_IDLE |
| cell | problems | WD and the network node | |
| | occurred | | |
| WD selects a | N/A | Activity is resumed by means | Go via |
| different cell from the | | of explicit signalling between | RRC_IDLE |
| same network node | | WD and the network node | |
| WD selects a cell of a | N/A | Activity is resumed by means | Go via |
| prepared network | | of explicit signalling between | RRC_IDLE |
| node (NOTE) | | WD and the network node | |
| WD selects a cell of a | N/A | Go via RRC_IDLE | Go via |
| different network | | | RRC_IDLE |
| node that is not | | | |
| prepared (NOTE) | | | |

(NOTE):
a prepared network node is a network node which has admitted the WD during an earlier executed handover (HO) preparation phase, or obtains the wireless device context during the Second Phase.

UL LBT Failure Handling

Detection of Consistent UL LBT Failures

During a radio link monitoring (RLM) procedure, the RLM reference signals (RSs) may be subject to LBT failures. Therefore, a wireless device may miss one or several RS receptions (due to LBT failure at the network node side), which would impact on triggering of RLF. For any uplink transmission, a wireless device may need to perform an LBT operation (at the wireless device side). The transmission may be dropped if the LBT operation fails. This can affect how to manage the counters of different MAC procedures such as preamble counter or scheduling request (SR) counter. If the preamble counter is not incremented, the wireless device may delay entering RLF procedure, which may not be desired. This may require a separate counter which counts the amount of LBT failures for random access (RA) transmission, upon which the wireless device can trigger RLF if the counter reaches a maximum value. A mechanism similar to Beam Failure Detection (BFD) has been discussed for detection of uplink (UL) LBT failures, which may reduce the work efforts in 3GPP to design a detection mechanism. The MAC entity may be configured by RRC with a consistent LBT failure recovery procedure. Consistent LBT failure is detected per UL bandwidth part (BWP) by counting LBT failure indications, for all UL transmissions, from the lower layers (i.e., lower OSI layers) to the MAC entity. 3GPP radio access network 2 (RAN2) has agreed to define a wireless device capability for consistent UL LBT failure detection and recovery. The feature may be optional for the wireless device.

RRC configures the following parameters in the lbt-FailureRecoveryConfig:
lbt-FailureInstanceMaxCount for the consistent LBT failure detection;
lbt-FailureDetectionTimer for the consistent LBT failure detection;

The following wireless device variables are used for the consistent LBT failure detection procedure:
LBT_COUNTER: counter for LBT failure indication which is initially set to 0.

For each activated Serving Cell configured with lbt-FailureRecoveryConfig, a simplified MAC procedure is described. The detailed procedure may be different depending on whether consistent UL LBT failures are detected in the primary cell (PCell or PSCell) or in an SCell.

1> if LBT failure indication has been received from lower layers:
2> start or restart the lbt-FailureDetectionTimer;
2> increment LBT_COUNTER by 1;
2> if LBT_COUNTER>=lbt-FailureInstanceMaxCount:
   3> declare consistent LBT failures for the active UL BWP

1> if the lbt-FailureDetectionTimer expires; or

1> if lbt-FailureDetectionTimer or lbt-FailureInstanceMaxCount is reconfigured by upper layers:
2> set LBT_COUNTER to 0.

A wireless device may be configured with several BWPs. UL LBT failure handling may be operated on a per BWP basis. The wireless device may maintain a timer and a counter for the active BWP. Whenever the wireless device switches to a different BWP. The wireless device may reset the timer and the counter in the new active BWP for detection of UL LBT failures. At the same time, the wireless device resets the timer and the counter in the de-activated BWP. If the active BWP includes several LBT subbands, it is enough for the wireless device to keep a common counter across LBT subbands with the same BWP. In other words, an UL LBT problem is only declared in case the number of LBT failures from any LBT subbands has reached a predefined counter.

Recovery Actions Upon Detection of Consistent UL LBT Failures

If a wireless device experiences LBT problems in its current active BWP, it may be beneficial for the wireless device to switch to another BWP prior to triggering of an RLF. The wireless device initiates a RA on an inactive BWP which has physical random access channel (PRACH) resource configured. Upon reception of the RA, the network node can decide if the wireless device needs to switch to another BWP. The network node can reply with a DCI or an RRC reconfiguration indicating the new BWP which may be a different one from which the wireless device has transmitted the RA in. After switching to the new active BWP, the wireless device can reset the counter for LBT problem detection.

If the wireless device has detected LBT problems for all configured BWPs with RA configured, the wireless device may declare an RLF for the cell and trigger RRC connection reestablishment.

In case an RLF event is triggered, the wireless device may follow the existing RRC connection reestablishment procedure to recover from the failure.

For a wireless device configured with SCells, if the wireless device has detected consistent UL LBT failures in an SCell, the wireless device informs the network node of the occurrence of the LBT failures, so the network node takes appropriate recovery actions, for example, to order the wireless device to switch to another BWP in the SCell, or to inactivate or de-configure the cell where the UL LBT failures have been detected. When consistent uplink LBT failures are detected in an SCell, a new MAC CE to report this to the network node where SCell belongs to is defined. The new MAC CE (i.e., named as UL LBT failure MAC CE) can indicate to the serving cell that consistent UL LBT failures have been detected. The network node knows in which BWP the wireless device is currently active and as a wireless device may only have one active BWP per cell, upon reception of the MAC CE, the network node can understand that the wireless device has experienced consistent UL LBT failures in its current active BWP in the indicated cell. The MAC CE format carries a bitmap field to indicate all the cells in which the wireless device has declared consistent UL LBT failures.

When consistent UL LBT failures are detected in a BWP of an SCell, the MAC entity may trigger a UL LBT failure MAC CE. If a UL grant is available in any serving cell for a new transmission, the wireless device may indicate to the Multiplexing and assembly entity to include a UL LBT failure MAC CE in the subsequent uplink transmission. If there is no UL grant available, the wireless device may trigger a scheduling request for requesting a new UL resource for the MAC CE.

The MAC CE is also applicable to the primary cell (PCell or PSCell). In the primary cell, the wireless device switches to another BWP and initiates RACH upon declaration of consistent LBT failures (e.g., a predefined number of LBT failures during a predefined time period). During the RACH procedure, especially for a contention-based random access (CBRA) based procedure, the wireless device can include the MAC CE (e.g., UL LBT failure MAC CE) in message 3 (Msg3) of the RACH procedure so that the network node can identify the purpose why the RA has been triggered by the wireless device. When consistent uplink LBT failures are detected on the PSCell, the wireless device informs the master node (MN) via the secondary cell group (SCG) failure information procedure after detecting consistent UL LBT failures in all configured BWPs.

An example of the recovery procedure for UL failure handling procedure for a wireless device in RRC connected mode is illustrated in FIG. 2. In particular, as wireless device (i.e., UE) MAC monitors (Block S10) UL LBT failures in a current active BWP of a serving cell. The wireless device determines (S20) whether a LBT_COUNTER reaches lbt-FailureInstanceMaxCount. If the wireless device determines that the LBT_COUNTER has not reached lbt-FailureInstanceMaxCount, the wireless device performs Block S10. If the wireless device determines that the LBT_COUNTER has been reached lbt-FailureInstanceMaxCount, The wireless device triggers (Block S30) consistent LBT failure in this active UL BWP.

The wireless device determines whether the associated cell (i.e., secondary cell in Block S10) is a SpCell. If the associated cell is a SpCell, the wireless device sends (Block S50) a UL LBT failure indication MAC CE in a different serving cell than the serving cell in which the LBT failure is detected. The network node triggers recovery actions for the wireless device including one of the following: BWP switching trigger by DCI or RRC signaling, and deactivation of the associated SCell.

Referring back to Block S40, if the associated cell is not a SpCell, the wireless device autonomously switches (Block S70) to another BWP with RA resource available, and initiates a RA (e.g., random access procedure) in that BWP of the SpCell. The wireless device determines (Block S80) whether consistent UL LBT failure is detected on all BWPs of the SpCell. If wireless device determines UL LBT failure is not detected on all BWPs of the SpCell, the wireless device performs Block S10. If wireless device determines UL LBT failure is detected on all BWPs of the SpCell, the wireless device triggers (Block S90) a radio link failure (RLF) procedure and performs RRC connection reestablishment.

Activation/Deactivation of SCells

As specified in wireless communication standards such as in 3GPP TS 38.321v. 16.0.0 clause 5.9, if the MAC entity is configured with one or more SCells, the network node may activate and deactivate the configured SCells. Upon configuration of an SCell, the SCell is deactivated unless the parameter sCellState is set to activated for the SCell within RRCReconfiguration message.

The configured SCell(s) is activated and deactivated by:
receiving the SCell Activation/Deactivation MAC CE described wireless communication standards such as in clause 6.1.3.10 in the 3GPP TS 38.321 v 16.0.0.0;
configuring sCellDeactivationTimer timer per configured SCell (except the SCell is configured with physical uplink control channel (PUCCH), if any): the associated SCell is deactivated upon its expiry.

The MAC entity may for each configured Scell:

1> if an Scell is configured with sCellState is set to activated upon Scell configuration, or an Scell Activation/Deactivation MAC CE is received activating the Scell:
2> if firstActiveDownlinkBWP-Id is not set to dormant BWP:
   3> activate the Scell according to the timing defined in wireless communication standards such as in TS 38.213 v.16.1.0; i.e., apply normal Scell operation including:
      4> sounding reference signal (SRS) transmissions on the Scell;
      4> channel state information (CSI) reporting for the Scell;
      4> PDCCH monitoring on the Scell;
      4> PDCCH monitoring for the Scell;
      4> PUCCH transmissions on the Scell, if configured.
   3> if the Scell was deactivated prior to receiving this Scell Activation/Deactivation MAC CE:
      4> activate the DL BWP and UL BWP indicated by firstActiveDownlinkBWP-Id and firstActiveUplinkBWP-Id respectively;
   3> start or restart the sCellDeactivationTimer associated with the Scell according to the timing defined in wireless communication standards such as in 3GPP TS 38.213 v.16.1.0;
   3> (re-)initialize any suspended configured uplink grants of configured grant Type 1 associated with this Scell according to the stored configuration, if any, and to start in the symbol according to rules wireless communication standards such as in clause 5.8.2 in 3GPP TS 38.321 v.16.0.0;
   3> trigger power headroom report (PHR) according to wireless communication standards such as in clause 5.4.6 in 3GPP TS 38.321 v.16.0.0.
2> else if firstActiveDownlinkBWP-Id is set to dormant BWP:
   3> stop the bwp-InactivityTimer of this Serving Cell, if running.
   3> not monitor the PDCCH on the BWP;
   3> not monitor the PDCCH for the BWP;
   3> not receive downlink (DL)-shared channel (SCH) on the BWP;
   3> perform CSI measurement for the BWP, if configured;
   3> stop all the UL behaviour, i.e., stop any UL transmission, suspend any configured uplink grant Type 1 associated with the Scell, clear any configured uplink grant of configured grant Type 2 associated with the Scell;
   3> if configured, perform beam failure detection and beam failure recovery for the Scell if beam failure is detected;
   3> if the Scell was deactivated prior to receiving this Scell Activation/Deactivation MAC CE:
      4> activate the DL BWP and UL BWP indicated by firstActiveDownlinkBWP-Id and firstActiveUplinkBWP-Id respectively;
   3> else if an Scell is configured with sCellState is set to activated upon Scell configuration:
      4> activate the DL BWP and UL BWP indicated by firstActiveDownlinkBWP-Id and firstActiveUplinkBWP-Id respectively;
   3> start or restart the sCellDeactivationTimer associated with the Scell according to the timing defined in wireless device communication standards such as in 3GPP TS 38.213 v.16.1.0.

1> else if an Scell Activation/Deactivation MAC CE is received deactivating the Scell; or

1> if the sCellDeactivationTimer associated with the activated Scell expires:
2> deactivate the Scell according to the timing defined in wireless communication standards such as in 3GPP TS 38.213 v.16.1.0;
2> stop the sCellDeactivationTimer associated with the Scell;
2> stop the bwp-InactivityTimer associated with the Scell;
2> deactivate any active BWP associated with the Scell;
2> clear any configured downlink assignment and any configured uplink grant Type 2 associated with the Scell respectively;
2> clear any physical uplink shared channel (PUSCH) resource for semi-persistent CSI reporting associated with the SCell;
2> suspend any configured uplink grant Type 1 associated with the SCell;
2> cancel all the triggered BFRs (e.g., beam failure recoveries) (as described in wireless communication standards such as in clause 5.17 in 3GPP TS 38.321 v.16.0.0) for this Serving Cell;
2> flush all HARQ buffers associated with the SCell;
2> cancel, if any, triggered consistent LBT failure for the SCell.

1> if PDCCH on the activated SCell indicates an uplink grant or downlink assignment; or

1> if PDCCH on the Serving Cell scheduling the activated SCell indicates an uplink grant or a downlink assignment for the activated SCell; or

1> if a MAC PDU is transmitted in a configured uplink grant or received in a configured downlink assignment:
2> restart the sCellDeactivationTimer associated with the SCell.

1> if the SCell is deactivated:
2> not transmit SRS on the SCell;
2> not report CSI for the SCell;
2> not transmit on UL-SCH on the SCell;
2> not transmit on RACH on the SCell;
2> not monitor the PDCCH on the SCell;
2> not monitor the PDCCH for the SCell;
2> not transmit PUCCH on the SCell.

Hybrid Automatic Repeat Request (HARQ) feedback for the MAC protocol data unit (PDU) containing SCell Activation/Deactivation MAC CE may not be impacted by PCell, PSCell and PUCCH SCell interruptions due to SCell activation/deactivation as described in wireless communication standards such as in 3GPP TS 38.133 v.16.3.0.

When SCell is deactivated, the ongoing Random Access procedure on the SCell, if any, is aborted.

As described in wireless communication standards, the configured SCell(s) is activated and deactivated by:
receiving the SCell Activation/Deactivation MAC CE;
configuring sCellDeactivationTimer timer per configured SCell (except the SCell configured with PUCCH, if any): the associated SCell is deactivated upon its expiry.
   The sCellDeactivationTimer allows the wireless device to control deactivation of the SCell.

As specified in wireless communication standards such as in 3GPP TS 38.331 v 16.0.0, the information element (IE) ServingCellConfig is used to configure (add or modify) the wireless device with a serving cell, which may be the SpCell or an SCell of an master cell group (MCG) or secondary cell group (SCG). The parameters herein are mostly wireless device specific but partly also cell specific (e.g., in additionally configured bandwidth parts). In the IE ServingCellConfig, a field sCellDeactivationTimer is included as below

ServingCellConfig Information Element

-- ASN1START
-- TAG-SERVINGCELLCONFIG-START
ServingCellConfig ::= SEQUENCE {
...
sCellDeactivationTimer ENUMERATED {ms20, ms40, ms80,
ms160, ms200, ms240, ms320, ms400, ms480, ms520, ms640, ms720,
ms840, ms 1280, spare2,spare1} OPTIONAL, -- Cond
ServingCellWithoutPUCCH
...
}

The field sCellDeactivationTimer is optional. If the field is absent, the wireless device applies the value infinity.

As specified in wireless communication standards, the sCellDeactivationTimer is started/restarted for an SCell for a wireless device when either of the below conditions is fulfilled.

1. the SCell is configured with sCellState is set to activate upon SCell configuration, or

2. an SCell Activation/Deactivation MAC CE is received that activates the SCell.

Based on either signaling way, the network node can control when to activate/deactivate an SCell for the wireless device.

In addition, the sCellDeactivationTimer is restarted by the UE when one of the below conditions is fulfilled

1) if PDCCH on the activated SCell indicates an uplink grant or downlink assignment; or

2) if PDCCH on the Serving Cell scheduling the activated SCell indicates an uplink grant or a downlink assignment for the activated SCell; or

3) if a MAC PDU is transmitted in a configured uplink grant or received in a configured downlink assignment:

In unlicensed operation, a wireless device may detect consistent LBT failures in an SCell on unlicensed band. There are two cases expected in this case.

Case 1: wireless device is configured with a valid sCellDeactivationTimer (i.e., with non-infinite value).

Subject to consistent LBT failure in the active BWP, the wireless device may neither transmit anything to the network node nor receive anything from the network node. The sCellDeactivationTimer may not be restarted. Sooner or later, the sCellDeactivationTimer would expire. The wireless device would deactivate the SCell according to the actions specified wireless communication standards. However, this is not efficient since the wireless device may still have other BWPs not suffering from consistent LBT failures. Deactivating the SCell without switching to other BWP would therefore cause unnecessary service interruption and resource wastage.

Case 2: the wireless device is not configured with a sCellDeactivationTimer field in the IE ServingCellConfig. According to the wireless communication standards such as 3GPP TS 38.331 v16.0.0, the wireless device may apply the value infinity. In this case, the wireless device may not be able to control the deactivation of the SCell by itself. In other words, the wireless device would then fully leave the control to the network node. However, due to consistent LBT failures, the network node may not be able to send any control command to the wireless device, which causes the SCell to be out of control.

Since the LBT failure detection and recovery is an optional feature for the wireless device, in case the wireless device is not configured or does not support LBT failure detection and recovery, the SCell suffering from consistent UL LBT failure would continue in a blocked state for a very long time for the wireless device. While at the same, the network node may be not aware of this and continue transmitting to wireless device. This may lead to service interruption and resource wastage for the wireless device.

Even though the wireless device is configured and supports LBT failure detection and recovery, upon detection of consistent UL LBT failure in the SCell, the wireless device can trigger LBT failure recovery via other cells. However, the other serving cells may be also congested or blocked because of high load or LBT failures, according to existing wireless communication standards, the wireless device would keep attempting recovery on any other cell for a longer period of time or an indefinite period of time or until otherwise stopped/interrupted. While at the same, the network node may be not aware of this and continue transmitting to the wireless device. This may lead to service interruption and resource wastage for the wireless device.

### SUMMARY

One or more embodiments described herein, at least in part improve wireless device handling of SCell in the event of consistent LBT failure. Herein, LBT failures may include DL LBT failures and/or UL LBT failures.

In one or more embodiments—an sCellDeactivationTimer based approach is provided where, a wireless device operating in unlicensed operation, upon expiry of the sCellDeactivationTimer caused by consistent LBT failure in an SCell, the wireless device is allowed to switch to another BWP for which consistent LBT failure is not triggered instead of directly performing SCell deactivation. The sCellDeactivationTimer is restarted after the wireless device switches to another BWP. In one example, the wireless device deactivates the SCell only if the wireless device has triggered consistent LBT failure in all configured BWPs in the SCell. In another example, the wireless device deactivates the SCell only if the wireless device has triggered consistent LBT failure in at least one other BWP in the SCell. In yet another example, the wireless device deactivates the SCell only if the wireless device has triggered consistent LBT failure in N configured BWPs in the SCell (N can be pre-defined, determined based on a pre-defined rule, or configured by another node). The wireless device may also have a counter to count the number of attempted BWPs. sCellDeactivationTimer is assumed to be configured by a network node or, if not configured, the wireless device may assume a pre-defined value (e.g., maximum configurable such as 1280 ms).

In one or more embodiments—LBT failure detection and recovery procedure based approach is provided where, for a wireless device configured with/supporting LBT failure detection and recovery in an SCell, there is no sCellDeactivationTimer configured in that SCell, in case the wireless device has detected consistent LBT failures in the SCell, the wireless device would perform LBT failure recovery via other serving cells. In addition, a first maximum time period/NEW timer is configured to the wireless device to allow the wireless device to perform the recovery via other serving cells. The time period or timer can be configured by a network node, pre-defined, or determined based on a pre-defined rule depending on conditions and/or at least one parameter etc.

After the timer is expired, the wireless device is allowed to autonomously perform
switch to another BWP in the SCell; or
deactivate the SCell

Some wireless device may be capable of performing both (and select one of the two action, e.g., based on a scenario or conditions) while other wireless devices may perform the same action.

In one or more embodiments such as those described above, the wireless device may also further provide a report message to the network node indicating the occurrence of consistent LBT failure in SCell.

The report message includes information of at least one of the following:
event of consistent LBT failure
index of the concerned SCell for which consistent LBT failure has been triggered
index of at least one concerned BWP where the SCell activation has been attempted and failed
time period elapsed since consistent LBT failure has been triggered in the concerned SCell
indices of the other serving cells via which the wireless device has attempted to transmit the report message indicating consistent LBT failure for the concerned SCell
current status of the concerned SCell for which consistent LBT failure has been triggered, i.e., either wireless device has switched to another BWP in the concerned SCell or the wireless device has deactivated the SCell,

Therefore, the instant disclosure advantageously provides one or more of the following:
Improve handling SCell in the event of consistent LBT failure which helps avoid an SCell from getting out of control;
Avoid status misalignment of an SCell caused by LBT failures between wireless device and network node;
Reduced delay for UL or UP data transmission due to consistent LBT failure
Avoidance of resource wastage in SCell due to consistent LBT failure

According to one aspect of the disclosure, a wireless device is provided. The wireless device includes processing circuitry configured to perform a listen before talk, LBT, recovery procedure based at least on one of expiration and triggering of a first timer, the first timer being associated with a LBT failure criterion that is met for at least a first bandwidth part, BWP, associated with a first secondary cell, SCell. The LBT recovery procedure includes one of switching to a second BWP associated with the first SCell for LBT recovery where the second BWP does not meet the LBT failure criterion, and selecting a second SCell for LBT recovery.

According to one or more embodiments of this aspect, the first timer is a SCell deactivation timer that is configured to deactivate the first SCell based on a determination that N BWPs associated with the first SCell meet the LBT failure criterion where N is a positive integer. According to one or more embodiments of this aspect, N corresponds to all the BWPs associated with the first SCell. According to one or more embodiments of this aspect, the first timer is configured by radio resource control, RRC, signaling for the first SCell in unlicensed operation.

According to one or more embodiments of this aspect, the first timer is set to a predefined value based on radio resource control, RRC, signaling not providing a value for the first timer. According to one or more embodiments of this aspect, the LBT recovery procedure is performed while the first timer is running. According to one or more embodiments of this aspect, the second SCell is selected based on one of: a random selection among a plurality of SCells including the second SCell, a channel occupancy level associated with each of the plurality of SCells, a lowest LBT failure occurrence metric associated with each of the plurality of SCells, and a respective priority associated with each of the plurality of SCells.

According to one or more embodiments of this aspect, the processing circuitry is further configured to trigger a second timer upon initiating the LBT recovery procedure where the second timer is configured to stop based on one of transmission of a recovery message, and receive acknowledgement of the recovery message. According to one or more embodiments of this aspect, the processing circuitry is configured to switch from the first SCell in response to the second timer expiring. According to one or more embodiments of this aspect, the processing circuitry is further configured to stop the first timer based on one of transmission of a recovery message, and receive acknowledgement of the recovery message.

According to one or more embodiments of this aspect, the processing circuitry is configured to, after expiration of the first timer, autonomously one of switch to another BWP, and deactivate the first SCell according to a same procedure as a procedure used when a SCell Activation/Deactivation medium access control, MAC, control element, CE, is received to deactivate an SCell. According to one or more embodiments of this aspect, the processing circuitry is further configured to cause transmission of a report message indicating LBT failures for the first SCell where the report message is transmitted on one of the second BWP and second SCell. According to one or more embodiments of this aspect, the report message includes one of: channel occupancy information, LBT statistics, at least one radio quality indicator, at least one service quality of service indicator, buffer status report, power headroom report, and an indication of one of at least one other BWP and SCell that meets the LBT failure criterion.

According to another aspect of the disclosure, a network node is provided. The network node includes processing circuitry configured to receive signaling associated with a wireless device is performing a listen before talk, LBT, recovery procedure where the LBT recovery procedure is based at least on one of expiration and triggering of a first timer. The first timer is associated with a LBT failure criterion that is met for at least a first bandwidth part, BWP associated with a first secondary cell, SCell, and the LBT recovery procedure includes one of: the wireless device switching to a second BWP associated with the first SCell for LBT recovery where the second BWP does not meet the LBT failure criterion, and the wireless device selects a second SCell for LBT recovery. Transmission of signaling is caused based at least on the LBT recovery procedure.

According to one or more embodiments of this aspect, the first timer is a SCell deactivation timer that is configured to cause the wireless device to deactivate the first SCell based on a determination that N BWPs associated with the first SCell meet the LBT failure criterion where N is a positive integer. According to one or more embodiments of this aspect, N corresponds to all the BWPs associated with the first SCell. According to one or more embodiments of this aspect, the processing circuitry is further configured to configure the first timer by radio resource control, RRC, signaling for the first SCell in unlicensed operation.

According to one or more embodiments of this aspect, the RRC signaling is configured to set the first timer to a predefined value based on the RRC signaling not providing a value for the first timer. According to one or more embodiments of this aspect, the LBT recovery procedure is configured to be performed while the first timer is running. According to one or more embodiments of this aspect, the second SCell is configured to be selected based on one of: a random selection among a plurality of SCells including the second SCell, a channel occupancy level associated with each of the plurality of SCells, a lowest LBT failure occurrence metric associated with each of the plurality of SCells, and a respective priority associated with each of the plurality of SCells.

According to one or more embodiments of this aspect, the processing circuitry is further configured to one of receive a recovery message and cause transmission of acknowledgment of the recovery message that is configured to stop a second timer that was initiated by the LBT recovery procedure. According to one or more embodiments of this aspect, the processing circuitry is further configured to one of receive a recovery message and cause transmission of acknowledgment of the recovery message that is configured to stop the first timer. According to one or more embodiments of this aspect, the processing circuitry is further configured to receive a report message indicating LBT failures for the first SCell where the report message is received on one of the second BWP and second SCell. According to one or more embodiments of this aspect, the report message includes one of: channel occupancy information, LBT statistics, at least one radio quality indicator, at least one service quality of service indicator, buffer status report, power headroom report, and an indication of one of at least one other BWP and SCell that meets the LBT failure criterion.

According to another aspect of the disclosure, a method implemented in a wireless device is provided. A listen before talk, LBT, recovery procedure is performed based at least on one of expiration and triggering of a first timer where the first timer is associated with a LBT failure criterion that is met for at least a first bandwidth part, BWP, associated with a first secondary cell, SCell. The LBT recovery procedure includes one of: switching to a second BWP associated with the first SCell for LBT recovery where the second BWP does not meet the LBT failure criterion, and selecting a second SCell for LBT recovery.

According to one or more embodiments of this aspect, the first timer is a SCell deactivation timer that is configured to deactivate the first SCell based on a determination that N BWPs associated with the first SCell meet the LBT failure criterion where N is a positive integer. According to one or more embodiments of this aspect, N corresponds to all the BWPs associated with the first SCell. According to one or more embodiments of this aspect, the first timer is configured by radio resource control, RRC, signaling for the first SCell in unlicensed operation.

According to one or more embodiments of this aspect, the first timer is set to a predefined value based on radio resource control, RRC, signaling not providing a value for the first timer. According to one or more embodiments of this aspect, the LBT recovery procedure is performed while the first timer is running. According to one or more embodiments of this aspect, the second SCell is selected based on one of: a random selection among a plurality of SCells including the second SCell, a channel occupancy level associated with each of the plurality of SCells, a lowest LBT failure occurrence metric associated with each of the plurality of SCells, and a respective priority associated with each of the plurality of SCells.

According to one or more embodiments of this aspect, a second timer is triggered upon initiating the LBT recovery procedure where the second timer is configured to stop based on one of transmission of a recovery message, and receive acknowledgement of the recovery message. According to one or more embodiments of this aspect, switching is performed from the first SCell in response to the second timer expiring. According to one or more embodiments of this aspect, the first timer is stopped based on one of transmission of a recovery message, and receive acknowledgement of the recovery message.

According to one or more embodiments of this aspect, after expiration of the first timer, autonomously one of switching to another BWP, and deactivating the first SCell according to a same procedure as a procedure used when a SCell Activation/Deactivation medium access control, MAC, control element, CE, is received to deactivate an SCell. According to one or more embodiments of this aspect, transmission of a report message indicating LBT failures for the first SCell is caused where the report message is transmitted on one of the second BWP and second SCell. According to one or more embodiments of this aspect, the report message includes one of: channel occupancy information, LBT statistics, at least one radio quality indicator, at least one service quality of service indicator, buffer status report, power headroom report, and an indication of one of at least one other BWP and SCell that meets the LBT failure criterion.

According to another aspect of the disclosure, a method implemented by a network node is provided. Signaling associated with a wireless device performing a listen before talk, LBT, recovery procedure is received. The LBT recovery procedure is based at least on one of expiration and triggering of a first timer where the first timer is associated with a LBT failure criterion that is met for at least a first bandwidth part, BWP associated with a first secondary cell, SCell. The LBT recovery procedure includes one of: the wireless device switching to a second BWP associated with the first SCell for LBT recovery where the second BWP does not meet the LBT failure criterion, and the wireless device selects a second SCell for LBT recovery. Transmission of signaling is caused based at least on the LBT recovery procedure.

According to one or more embodiments of this aspect, the first timer is a SCell deactivation timer that is configured to cause the wireless device to deactivate the first SCell based on a determination that N BWPs associated with the first SCell meet the LBT failure criterion where N is a positive integer. According to one or more embodiments of this aspect, N corresponds to all the BWPs associated with the first SCell. According to one or more embodiments of this aspect, the first timer is configured by radio resource control, RRC, signaling for the first SCell in unlicensed operation. According to one or more embodiments of this aspect, the RRC signaling is configured to set the first timer to a predefined value based on the RRC signaling not providing a value for the first timer.

According to one or more embodiments of this aspect, the LBT recovery procedure is configured to be performed while the first timer is running. According to one or more embodiments of this aspect, the second SCell is configured to be selected based on one of: a random selection among a plurality of SCells including the second SCell, a channel occupancy level associated with each of the plurality of SCells, a lowest LBT failure occurrence metric associated with each of the plurality of SCells, and a respective priority associated with each of the plurality of SCells. According to one or more embodiments of this aspect, one of a recovery message is received and transmission is caused of acknowledgment of the recovery message that is configured to stop a second timer that was initiated by the LBT recovery procedure.

According to one or more embodiments of this aspect, one of a recovery message is received and transmission is caused of acknowledgment of the recovery message that is configured to stop the first timer. According to one or more embodiments of this aspect, receiving a report message indicating LBT failures for the first SCell, the report message being received on one of the second BWP and second SCell. According to one or more embodiments of this aspect, the report message includes one of channel occupancy information, LBT statistics, at least one radio quality indicator, at least one service quality of service indicator, buffer status report, power headroom report, and an indication of one of at least one other BWP and SCell that meets the LBT failure criterion.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of radio link monitoring of the serving cell followed by RRC re-establishment to a target cell;

FIG. 2 is a diagram of UL failure handling procedure for a UE/WD in connected mode;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of another example process in a network node according to some embodiments of the present disclosure;

FIG. 11 is a flowchart of an example process in a wireless device according to some embodiments of the present disclosure; and

FIG. 12 is a flowchart of another example process in a wireless device according to some embodiments of the present disclosure.

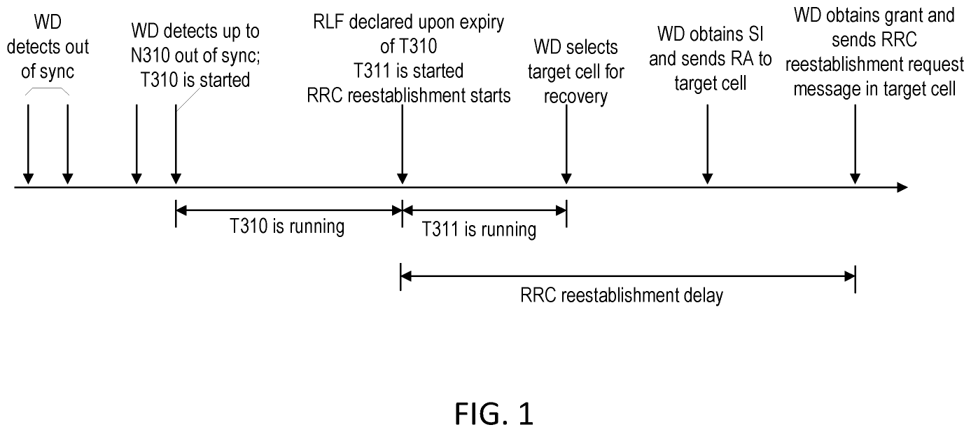

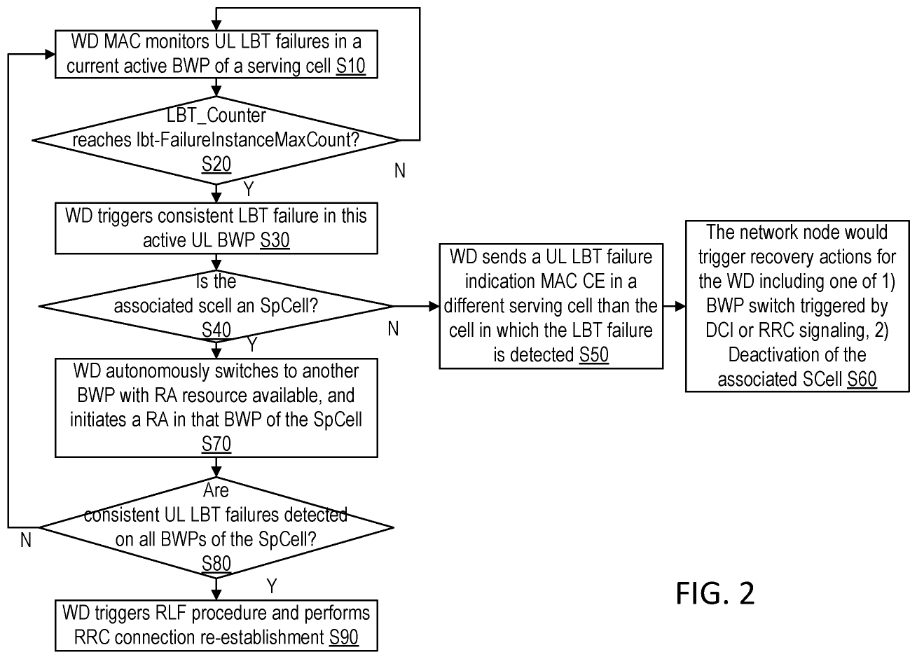

### DETAILED DESCRIPTION

Before describing in detail exemplary embodiments, it is noted that the embodiments reside primarily in combinations of apparatus components and processing steps related to listen before talk (LBT) procedures. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information.

A cell may be generally a communication cell, e.g., of a cellular or mobile communication network, provided by a node. A serving cell may be a cell on or via which a network node (the node providing or associated to the cell, e.g., base station, gNB or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., at least one setting and/or register entry and/or LBT failure procedures and LBT failure criterion. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

A licensed band or spectrum may be a part of the frequency spectrum that is and/or has to be licensed for use, e.g. by a telecommunications operator. An unlicensed band or spectrum may be a part of the frequency spectrum that is available without such license. WLAN/WiFi usually uses such unlicensed bands. The requirements for using licensed bands are usually quite different from unlicensed bands, e.g. due to licensed bands being controlled by one operator, whereas unlicensed bands usually are not subject to a centralized operator. Thus, LBT procedures are usually required for unlicensed bands, which may be adapted to facilitate fair distribution of access to the unlicensed spectrum.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

As used herein in one or more embodiments, a wireless device deactivating or activating a SCell corresponds to the wireless device activating or deactivating a configuration for using the SCell at the wireless device. Upon activation of a SCell, the wireless device is able to perform transmission or reception using resources in the SCell. Upon deactivation of a SCell, the wireless device is not able to perform transmission or reception using resources in the SCell. The SCell, itself, that is provided by the network node may remain operational irrespective of the deactivating/activating of the SCell at the wireless device.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide LBT procedures provide one or more of the following:
improve handling SCell in event of consistent LBT failure, avoid an SCell to be out of control;
avoid status misalignment of an SCell caused by LBT failures between the wireless device and network node;
reduced delay for uplink (UL) data transmission due to consistent LBT failure;
avoidance of resource wastage in SCell due to consistent LBT failure.

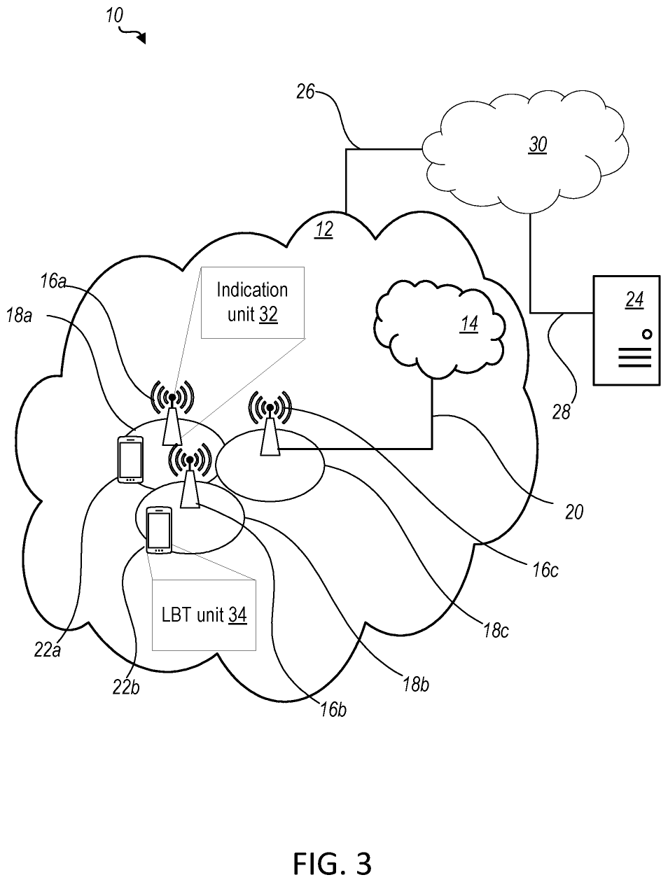

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18 or cells 18). A cell 18 may be a primary cell (PCell), secondary cell (SCell) or a primary SCell. Further, each network node 16 may provide one or more cells 18.

Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform one or more network node 16 functions as described herein such as with respect to one or more LBT procedures. A wireless device 22 is configured to include a LBT unit 34 which is configured to perform one or more wireless device 22 functions as described herein such as with respect to one or more LBT procedures.

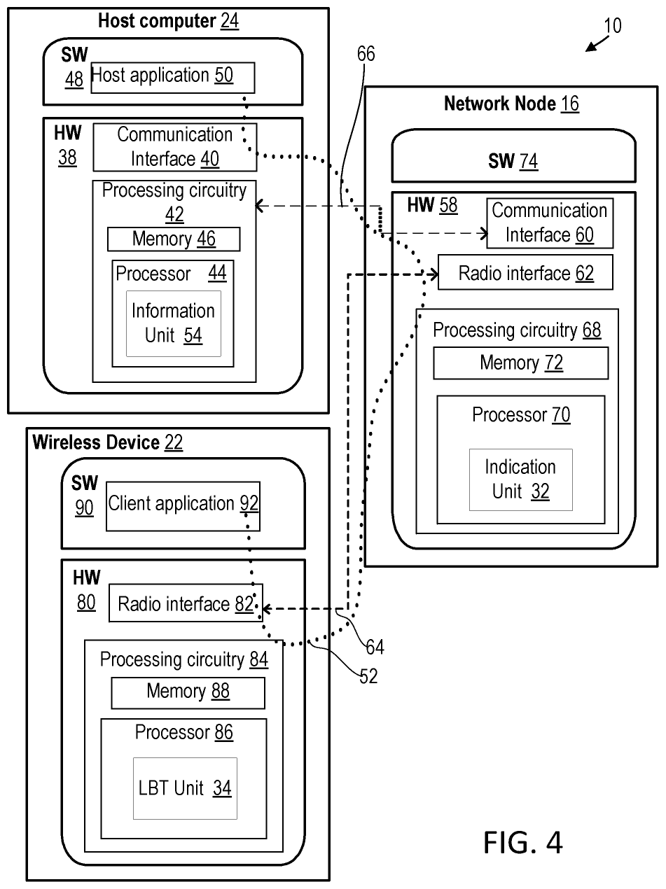

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider provide information and/or perform one or more functions related to the one or more LBT procedures and/or failure of such LBT procedure(s).

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indication unit 32 configured to configure and/or receive indications of one or more LBT procedures such as those procedures/actions based on an LBT failure criterion being met for at least one BWP as described herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a LBT unit 34 configured perform one or more LBT procedure such as those procedures/actions based on an LBT failure criterion being met for at least one BWP as described herein.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as indication unit 32, and LBT unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

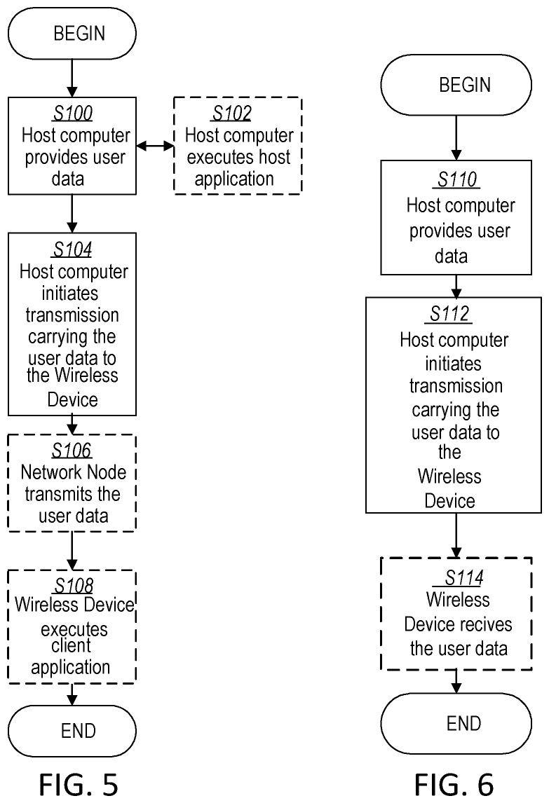

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

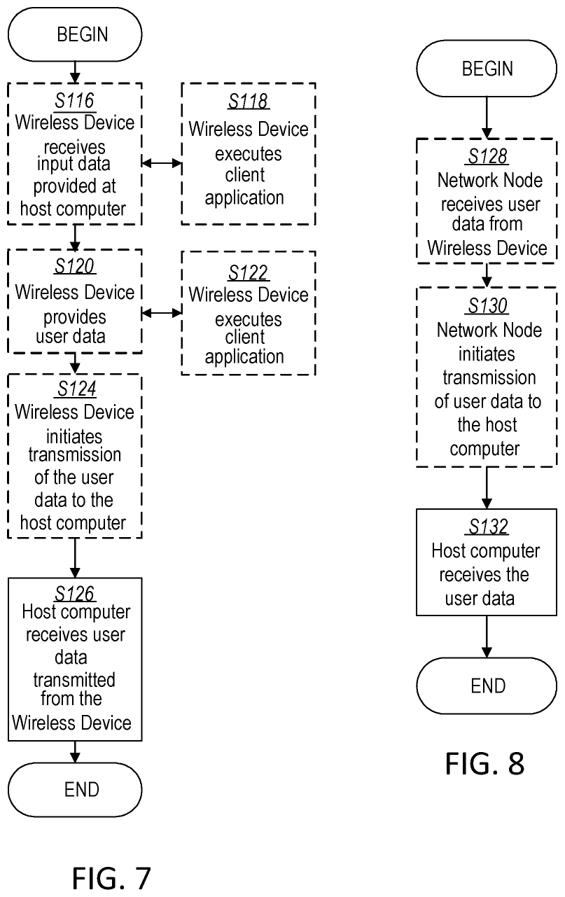

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

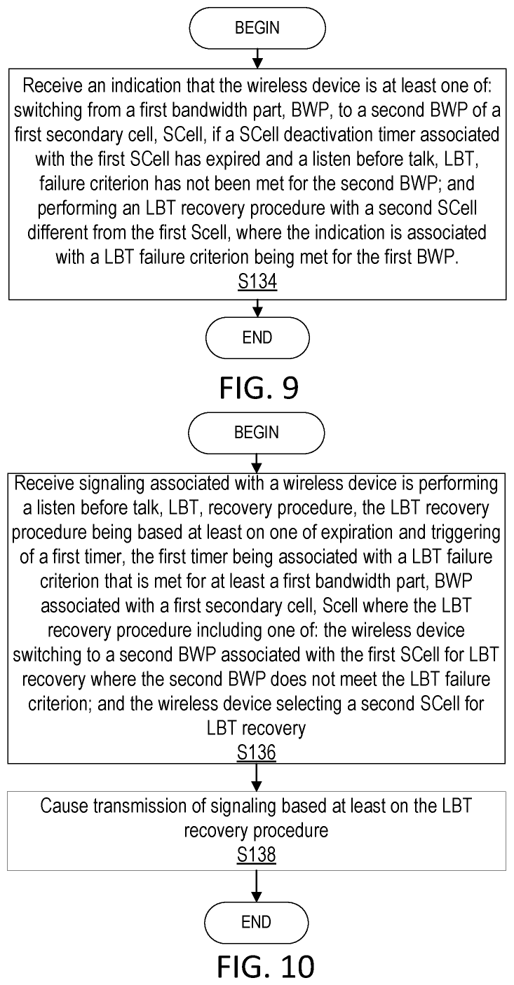

FIG. 9 is a flowchart of an example process in a network node 16 according to some embodiments of the present disclosure. One or more Blocks and/or functions performed by network node 16 may be performed by one or more elements of network node 16 such as by indication unit 32 in processing circuitry 68, processor 70, radio interface 62, etc. In one or more embodiments, network node 16 is configured to receive (Block S134) an indication that the wireless device is at least one of: (a) switching from a first bandwidth part, BWP, to a second BWP of a first secondary cell, SCell, if a SCell deactivation timer associated with the first SCell has expired and a listen before talk, LBT, failure criterion has not been met for the second BWP; and (b) performing an LBT recovery procedure with a second SCell different from the first SCell, where the indication is associated with a LBT failure criterion being met for the first BWP, as described herein.

In one or more embodiments, network node 16 is configured to receive an indication that the wireless device has deactivated the first SCell if the LBT failure criterion is met for a plurality of BWP including the first BWP that are associated with the first SCell, as described herein. In one or more embodiments, the second SCell is selected based on at least one of the following: a random selection; configuration of the wireless device; a lowest channel occupancy among SCells; a lowest LBT failure occurrence among SCells; and respective SCell priority order, as described herein. In one or more embodiments, network node 16 is configured to receive an indication of the wireless device attempting to perform a LBT recovery procedure with a third SCell, as described herein.

FIG. 10 is a flowchart of another example process in a network node 16 according to some embodiments of the present disclosure. One or more Blocks and/or functions performed by network node 16 may be performed by one or more elements of network node 16 such as by indication unit 32 in processing circuitry 68, processor 70, radio interface 62, etc. In one or more embodiments, network node 16 is configured to receive (Block S136) signaling associated with a wireless device 22 performing a listen before talk, LBT, recovery procedure where the LBT recovery procedure is based at least on one of expiration and triggering of a first timer and the first timer is associated with a LBT failure criterion that is met for at least a first bandwidth part, BWP associated with a first secondary cell, SCell 18, where the LBT recovery procedure includes one of the wireless device 22 switching to a second BWP associated with the first SCell 18 for LBT recovery where the second BWP failing to meet the LBT failure criterion, and the wireless device 22 selecting a second SCell 18 for LBT recovery, as described herein. The network node 16 is configured to cause (Block S138) transmission of signaling based at least on the LBT recovery procedure, as described herein. Signaling may refer to any messaging, data and/or control transmission associated with the LBT recovery procedure where the signaling may be performed before, during and/or after the LBT recovery procedure.

According to one or more embodiments, the first timer is a SCell deactivation timer that is configured to cause the wireless device 22 to deactivate the first SCell 18 based on a determination that N BWPs associated with the first SCell 18 meet the LBT failure criterion, N being a positive integer, as described herein. According to one or more embodiments, N corresponds to all the BWPs associated with the first SCell 18. According to one or more embodiments, the processing circuitry 68 is further configured to configure the first timer by radio resource control, RRC, signaling for the first SCell 18 in unlicensed operation.

According to one or more embodiments, the RRC signaling is configured to set the first timer to a predefined value based on the RRC signaling not providing a value for the first timer. According to one or more embodiments, the LBT recovery procedure is configured to be performed while the first timer is running. According to one or more embodiments, the second SCell 18 is configured to be selected based on one of: a random selection among a plurality of SCells 18 including the second SCell 18, a channel occupancy level associated with each of the plurality of SCells 18, a lowest LBT failure occurrence metric associated with each of the plurality of SCells 18, and a respective priority associated with each of the plurality of SCells 18.

According to one or more embodiments, the processing circuitry 68 is further configured to one of receive a recovery message and cause transmission of acknowledgment of the recovery message that is configured to stop a second timer that was initiated by the LBT recovery procedure. According to one or more embodiments, the processing circuitry 68 is further configured to one of receive a recovery message and cause transmission of acknowledgment of the recovery message that is configured to stop the first timer. According to one or more embodiments, the processing circuitry 68 is further configured to receive a report message indicating LBT failures for the first SCell 18 where the report message is received on one of the second BWP and second SCell 18. According to one or more embodiments, the report message includes one of: channel occupancy information, LBT statistics, at least one radio quality indicator, at least one service quality of service indicator, buffer status report, power headroom report; and an indication of one of at least one other BWP and SCell 18 that meets the LBT failure criterion.

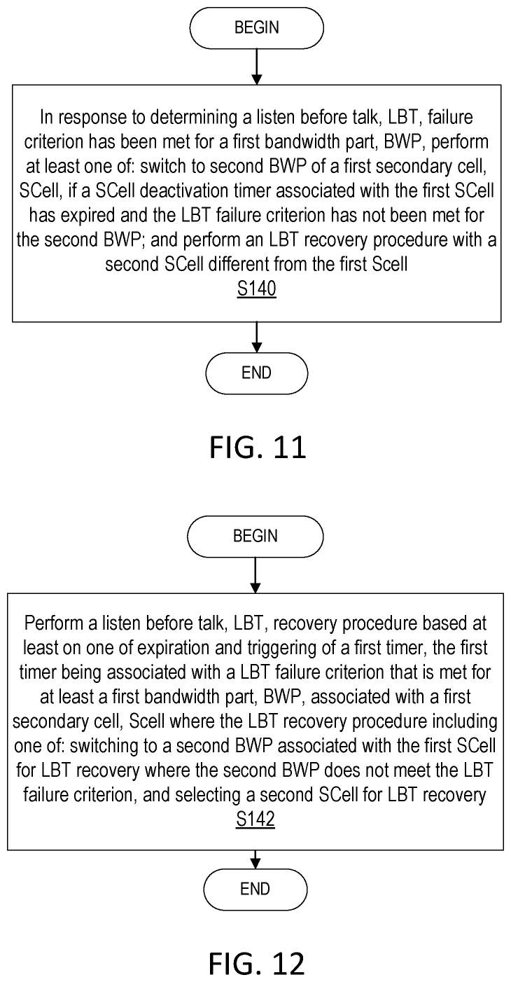

FIG. 11 is a flowchart of an example process in a wireless device 22 according to some embodiments of the present disclosure. One or more Blocks and/or functions performed by wireless device 22 may be performed by one or more elements of wireless device 22 such as by LBT unit 34 in processing circuitry 84, processor 86, radio interface 82, etc. In one or more embodiments, wireless device is configured to in response to determining a listen before talk, LBT, failure criterion has been met for a first bandwidth part, BWP, perform (Block S140) at least one of: (a) switch to second BWP of a first secondary cell, SCell, if a SCell deactivation timer associated with the first SCell has expired and the LBT failure criterion has not been met for the second BWP; and (b) perform an LBT recovery procedure with a second SCell different from the first SCell.

In one or more embodiments, wireless device is configured to deactivate the first SCell if the LBT failure criterion is met for a plurality of BWP including the first and second BWPs that are associated with the first SCell, and trigger a report indicating the deactivation of the first SCell, as described herein. In one or more embodiments, wireless device 22 is configured to select the second SCell based on at least one of the following: a random selection; configuration of the wireless device; a lowest channel occupancy among SCells; a lowest LBT failure occurrence among SCells; and respective SCell priority order, as described herein. In one or more embodiments, wireless device is configured to trigger a timer associated with the LBT recovery procedure; and upon expiration of the timer, initiate a LBT recovery procedure with a third SCell, as described herein.

FIG. 12 is a flowchart of an example process in a wireless device 22 according to some embodiments of the present disclosure. One or more Blocks and/or functions performed by wireless device 22 may be performed by one or more elements of wireless device 22 such as by LBT unit 34 in processing circuitry 84, processor 86, radio interface 82, etc. In one or more embodiments, wireless device 22 is configured to perform (Block S142) a listen before talk, LBT, recovery procedure based at least on one of expiration and triggering of a first timer where the first timer is associated with a LBT failure criterion that is met for at least a first bandwidth part, BWP, associated with a first secondary cell, SCell 18, and where the LBT recovery procedure includes one of switching to a second BWP associated with the first SCell 18 for LBT recovery where the second BWP does not meet the LBT failure criterion, and selecting a second SCell 18 for LBT recovery, as described herein.

According to one or more embodiments, the first timer is a SCell deactivation timer that is configured to deactivate the first SCell 18 based on a determination that N BWPs associated with the first SCell 18 meet the LBT failure criterion where N is a positive integer, as described herein. According to one or more embodiments, N corresponds to all the BWPs associated with the first SCell 18. According to one or more embodiments, the first timer is configured by radio resource control, RRC, signaling for the first SCell 18 in unlicensed operation.

According to one or more embodiments, the first timer is set to a predefined value based on radio resource control, RRC, signaling not providing a value for the first timer. According to one or more embodiments, the LBT recovery procedure is performed while the first timer is running. According to one or more embodiments, the second SCell 18 is selected based on one of a random selection among a plurality of SCells 18 including the second SCell 18, a channel occupancy level associated with each of the plurality of SCells 18, a lowest LBT failure occurrence metric associated with each of the plurality of SCells 18, and a respective priority associated with each of the plurality of SCells 18.

According to one or more embodiments, the processing circuitry 84 is further configured to: trigger a second timer upon initiating the LBT recovery procedure, the second timer being configured to stop based on one of transmission of a recovery message, and receive acknowledgement of the recovery message. According to one or more embodiments, the processing circuitry 84 is configured to switch from the first SCell 18 in response to the second timer expiring. According to one or more embodiments, the processing circuitry 84 is further configured to stop the first timer based on one of: transmission of a recovery message; and receive acknowledgement of the recovery message.

According to one or more embodiments, the processing circuitry 84 is configured to, after expiration of the first timer, autonomously one of: switch to another BWP; and deactivate the first SCell 18 according to a same procedure as a procedure used when a SCell Activation/Deactivation medium access control, MAC, control element, CE, is received to deactivate an SCell 18. According to one or more embodiments, the processing circuitry 84 is further configured to cause transmission of a report message indicating LBT failures for the first SCell 18, the report message being transmitted on one of the second BWP and second SCell 18. According to one or more embodiments, the report message includes one of: channel occupancy information, LBT statistics, at least one radio quality indicator, at least one service quality of service indicator, buffer status report, power headroom report, and an indication of one of at least one other BWP and SCell 18 that meets the LBT failure criterion.

Having generally described arrangements for one or more LBT procedures such as those procedures/actions based on an LBT failure criterion being met for at least one BWP, details for these arrangements, functions and processes are provided as follows, and which may be implemented by the network node 16, wireless device 22 and/or host computer 24.

Embodiments provide one or more LBT procedures such as those procedures/actions based on an LBT failure criterion being met for at least one BWP. One or more network node 16 functions described below may be performed by one or more of processing circuitry 68, processor 70, radio interface 62, indication unit 32, etc. One or more wireless device 22 functions described below may be performed by one or more of processing circuitry 84, processor 86, radio interface 82, LBT unit 34, etc.

The proposed mechanism is applicable to both licensed and unlicensed operations (such as licensed assistant access (LAA)/enhanced-LAA (eLAA)/further enhanced-LAA (feLAA)/MuLteFire, and NR unlicensed operation (NR-U)). The term “consistent LBT failure” as used herein means an event for which the wireless device 22 has consistently detected LBT failure instances in the UL, or that the network node 16 has consistently detected LBT failure instances in the DL. The term LBT may also be interchangeably referred to herein as a clear channel assessment (CCA), shared spectrum access procedure, etc. The carrier on which the LBT is applied may belong to a shared spectrum or an unlicensed band or band with contention based access, etc. If at least one event is declared, the WD 22 may need to take recovery actions. Below embodiments are not restricted by terms. Any similar term is equally applicable here.

In a first example, for wireless device 22 is configured to operate in unlicensed operation, where upon expiry of the sCellDeactivationTimer (i.e., timer associated with SCell deactivation) caused by consistent LBT failure (i.e., example of a LBT failure criterion) in an SCell 18, the wireless device 22 is allowed to switch to another BWP for which consistent LBT failure is not triggered instead of directly performing SCell deactivation. In one or more embodiments, as used herein, consistent LBT failure may correspond to a minimum number of LBT failures, as determined for example by the wireless device 22, over a predefined period of time. The sCellDeactivationTimer is restarted after the wireless device 22 switches to another BWP. In one example, the wireless device 22 deactivates the SCell 18 only if wireless device 22 has triggered consistent LBT failure in all configured BWPs in the SCell 18. A wireless device 22 deactivating a SCell 18 may refer to the wireless device 22 at least temporarily stopping communication with the SCell 18 and/or leaving an RRC connected state with the deactivated SCell 18 as opposed to the SCell 18, itself, deactivating, such that the SCell 18 may still continue to serve other wireless devices 22 after the wireless device 22 “deactivates” the SCell 18.

In another example, the wireless device 22 deactivates the SCell 18 only if the wireless device 22 has triggered consistent LBT failure in at least one other BWP in the SCell 18. In yet another example, the wireless device 22 deactivates the SCell 18 only if the wireless device 22 has triggered consistent LBT failure in N configured BWPs in the SCell 18, i.e., example of a LBT failure criterion (N can be pre-defined, determined based on a pre-defined rule, or configured by another node). The wireless device 22 may also have a counter to count the number of attempted BWPs. sCellDeactivationTimer is may be configured by a network node 16 or, if not configured, the wireless device 22 may assume a pre-defined value for the sCellDeactivationTimer (e.g., maximum configurable such as 1280 ms).

To address non-configured sCellDeactivationTimer in the RRC IE ServingCellConfig, one or more of the following options may be configured/provided:
for unlicensed operation, a rule is added to the wireless communication standard so that sCellDeactivationTimer may be configured in the RRC IE ServingCellConfig for every SCell 18 in unlicensed operation, or
Alternatively, when the field sCellDeactivationTimer is optional and the field is absent, the wireless device 22 applies a non-infinite value. As one option, this value can be fixed as the maximum value in the range of the field sCellDeactivationTimer specified in one or more wireless communication standards such as in RRC specifications, such as 1280 ms. As another option, this value is configured by the network node via RRC signaling, MAC CE or DCI, or SI, or
A maximum time is defined for the wireless device 22 (e.g., pre-defined) and applied by the wireless device 22 (e.g., to have an effect similar to that of the timer) when the sCellDeactivationTimer is not configured. Upon expiring of this time, the SCell 18 could be deactivated or at least the SCell activation procedure can be stopped.

In the first example, the wireless device 22 is not required to be configured or supporting LBT failure detection and recovery procedure in SCell 18. The wireless device 22 can rely on the sCellDeactivationTimer to overcome consistent LBT failures in SCell.

Upon trigger of consistent LBT failure, after the wireless device 22 has performed one of the options, i.e., either switch to another BWP in the same SCell, or deactivate the SCell 18, the wireless device 22 sends a report message to the network node 16 and informs the network node 16 of the occurrence of consistent LBT failures in the SCell 18.

As in the second example, for a wireless device 22 configured with/supporting LBT failure detection and recovery in an SCell 18, there is no sCellDeactivationTimer configured in that SCell 18. In this example, in case the wireless device 22 has detected consistent LBT failures (i.e., example of a LBT failure criterion) in the SCell 18, the wireless device 22 would perform LBT failure recovery via other serving cells 18. In addition, a first maximum time period is configured to the wireless device 22 to allow the wireless device 22 to perform the recovery via other serving cells 18. The time period or timer can be configured by a network node 16, pre-defined, or determined based on a pre-defined rule depending on conditions and/or at least one parameter etc. A first timer may be defined accordingly. The timer/the time period is started when the wireless device declares consistent LBT failure in the SCell 18, e.g., LBT_COUNTER>=lbt-FailureInstanceMaxCount is fulfilled in the active BWP in the SCell. While the timer is running/during the time period, the wireless device 22 initiates a recovery procedure in any other serving cell 18 for which consistent LBT failure has not been triggered. If there are multiple other serving cells 18 available, the wireless device 22 can apply at least one of below options to select the serving cell 18.

Option 1: the wireless device 22 selects the serving cell 18 randomly or based on the wireless device 22 implementation.

Option 2: the wireless device 22 selects the serving cell 18 with lowest channel occupancy or lowest LBT failure occurrence among all cells 18.

Option 3: the wireless device 22 selects the cell 18 following a decreasing priority order. For each serving cell 18, the network node 16 may configure a priority index. The configuration is signaled to the wireless device 22 via system information, RRC signaling, MAC CE or DCI.

In addition, for any above option, a second timer or a second time period is configured to allow the wireless device 22 to try the recovery procedure for the concerned SCell 18 via another serving cell 18. The second timer or the second time period is started upon initiating the recovery procedure in another serving cell 18 for the concerned SCell 18 in which consistent LBT failure has been triggered. When the second timer or the second time period is elapsed, the wireless device 22 may need to switch to a different serving cell 18 to continue the recovery procedure. The second timer or the second time period is stopped when at least one of the below conditions is fulfilled:
the wireless device 22 has transmitted the recovery message, i.e., the LBT failure MAC CE for the SCell 18 in which consistent LBT failure has been triggered has been transmitted in a serving cell 18 after a success LBT operation.
the network node 16 has acknowledged reception of the recovery message or the network node 16 has performed further actions to help the wireless device 22 to recover from consistent LBT failures in the concerned SCell 18 in which consistent LBT failure has been triggered. The further actions can be for example one of the below:
   order/configure/trigger the wireless device 22 to switch to another BWP in the concerned SCell 18;
   the concerned SCell 18 has been deactivated for the wireless device 22;
   the concerned SCell 18 has been reconfigured for the wireless device 22.

The first timer or the first time period can be stopped similarly as for the second timer. In other words, when one of the above conditions is fulfilled, the wireless device 22 can stop both the first timer and the second timer, if they are running or counting down.

When the first timer/time period is expired, the wireless device 22 is allowed and/or configured to perform one of the below options, autonomously:

Option 1: In the SCell 18, if there is another BWP for which consistent LBT failure has not been triggered, the wireless device 22 switches to that BWP. The wireless device 22 can start to transmit or receive in that BWP. Specifically, the wireless device 22 may perform at least one of the below actions:

1. transmit on UL-SCH on the BWP;

2. transmit on radio access channel (RACH) on the BWP, if PRACH occasions are configured;

3. monitor the physical downlink control channel (PDCCH) on the BWP;

4. PDCCH monitoring for the SCell 18;

5. transmit physical uplink control channel (PUCCH) on the BWP, if configured;

6. report CSI for the BWP;

7. transmit SRS on the BWP, if configured;

8. receive DL-SCH on the BWP; and

9. (re-)initialize any suspended configured uplink grants of configured grant Type 1 on the active BWP according to the stored configuration, if any, and to start to transmit according to the configuration.

Option 2: In the SCell 18, if there is no any other BWP for which consistent LBT failure has not been triggered, in other words, consistent LBT failure has been triggered in all BWPs in the SCell 18, in this case, the wireless device 22 deactivates the SCell 18 as if the wireless device 22 has received an SCell Activation/Deactivation MAC CE deactivating the SCell 18. In particular, the wireless device 22 may perform at least one of the below actions:

1. deactivate the SCell 18;

2. stop the sCellDeactivationTimer associated with the SCell 18;

3. stop the bwp-InactivityTimer associated with the SCell 18;

4. deactivate any active BWP associated with the SCell 18;

5. clear any configured downlink assignment and any configured uplink grant Type 2 associated with the SCell 18 respectively;

6. clear any physical uplink shared channel (PUSCH) resource for semi-persistent CSI reporting associated with the SCell 18;

7. suspend any configured uplink grant Type 1 associated with the SCell 18;

8. cancel all the triggered BFRs for this Serving Cell 18;

9. flush all HARQ buffers associated with the SCell 18; and

10. cancel, if any, triggered consistent LBT failure for the SCell 18.

Upon expiry of the first timer/time period, after the wireless device 22 has performed one of the above options, i.e., either switch to another BWP in the same SCell 18, or deactivate the SCell 18, the wireless device 22 sends a report message to the network node 16 and informs the network node 16 of occurrence of consistent LBT failures in the SCell 18.

In one or more embodiments, the wireless device 22 is not required to be configured with the sCellDeactivationTimer for an SCell 18. The wireless device 22 can rely on LBT failure detection and recovery procedure to overcome consistent LBT failures in SCell 18.

In one or more embodiments, in case both 1) wireless device 22 is configured or supporting LBT failure detection and recovery procedure, and 2) the sCellDeactivationTimer is configured in an SCell 18, the wireless device 22 may then have two parallel mechanisms which can handle consistent LBT failures in the same time.

As one alternative, the wireless device 22 is configured to only rely on one mechanism to handle LBT failures, i.e., either only use the sCellDeactivationTimer or only use LBT failure detection and recovery procedure. Which mechanism is applicable for a wireless device 22 can be signaled to the wireless device 22 by the network node 16 via system information, RRC signaling, MAC CE or DCI, etc.

As another alternative, which mechanism is applicable for a wireless device 22 is specified a rule in a wireless communication standard such that wireless device 22 is preconfigured/configured with the rule.

As yet another alternative, the wireless device 22 chooses the mechanism which is triggered first. The wireless device 22 then applies the selected/chosen mechanism to handle LBT failures. Meanwhile, the wireless device 22 may ignore another mechanism even if it is also triggered by LBT failures later on.

In one or more embodiments, for any above embodiment, the report message includes information of at least one of the below:
event of consistent LBT failure
index of at least one concerned BWP in the concerned SCell 18 for which consistent LBT failure has been triggered or where the SCell 18 activation has been attempted
index of the concerned SCell 18 for which consistent LBT failure has been triggered or where the SCell 18 activation has been attempted
time period elapsed since consistent LBT failure has been triggered in the concerned SCell 18
indices of the other serving cells via which the wireless device 22 has attempted to transmit the report message indicating consistent LBT failure for the concerned SCell 18
current status of the concerned SCell 18 for which consistent LBT failure has been triggered, i.e., either the wireless device 22 has switched to another BWP in the concerned SCell 18 or the wireless device 22 has deactivated the SCell 18.

The report message indicating LBT failures for an SCell 18 may be sent by the wireless device 22 on the same SCell 18 (on a different BWP) or a different serving cell 18. The report message may be carried in a MAC CE or in a RRC signaling message. The report message may be carried in a RACH report or in a RLF report.

In addition, any of below additional information may be also reported in one or multiple report messages (reported for a measurement object, a carrier, for a group of carriers, for a certain PLMN, for a cell, per physical cell ID (PCI), per BWP, per beam/SS block (SSB), etc.):
Channel occupancy, e.g., based on received signal strength indicator, RSSI.
LBT statistics, e.g., number of LBT failures and/or successes, LBT failure/success ratio (e.g., calculated over a certain time period or using exponential averaging of successive time periods), LBT failure rate (e.g., calculated over a certain time period or using exponential averaging of successive time periods), LBT modes (i.e., load based equipment (LBE) or frame based equipment (FBE) and LBT types (i.e., Category 1, 2, 3 or 4) with which the wireless device 22 has detected LBT failures. Either of these could be reported per LBT type or per CAPC, or per UL/DL, or per service/LCH/LCG.
Radio quality indicators, such as reference signal received power (RSRP), reference signal received quality (RSRQ), received signal strength indicator (RSSI), signal to interference ratio (SNR), signal to interference plus noise radio (SINR), etc.
Service QoS indicators such as latency, packet loss, priority, jitter etc.
Buffer status report.
Power headroom report.
The indices for other cells/BWPs/carriers/channels/subbands/public land mobile networks (PLMNs) that suffer from LBT failures or high channel occupancy.

In one or more embodiments, the network node 16 replies with acknowledgement upon reception of the report. The acknowledgement may be indicated via at least one of below signaling procedures/methods:

1. a DCI addressed to the cell radio network temporary identifier (C-RNTI) associated with the wireless device 22.

2. a RRC signaling

3. a MAC CE.

The network node 16 may also provide further signaling to wireless device 22 on at least one of:
Switch to a different BWP of the concerned SCell 18 for which wireless device 22 has triggered consistent LBT failure
Confirmation of the deactivation of the concerned SCell for which wireless device 22 has triggered consistent LBT failure
reconfiguration of the concerned SCell for which wireless device 22 has triggered consistent LBT failure
Deactivation of the concerned SCell 18 for which wireless device 22 has triggered consistent LBT failure and wireless device 22 has not deactivated that SCell autonomously yet

According to one or more embodiments, for any above embodiment, the network node 16 signals relevant configurations to the wireless device 22. The configuration is signaled via system information, dedicated RRC signaling, MAC CE or DCI, etc.

According to one or more embodiments, at least one of the below wireless device 22 capability bits may be defined.
Wireless device 22 capability bit indicating whether the wireless device 22 supports to autonomously switch to another BWP in an SCell 18 upon trigger of consistent LBT failure in that SCell 18.
Wireless device 22 capability bit indicating whether the wireless device 22 supports to autonomously deactivate an SCell 18 upon trigger of consistent LBT failure in that SCell 18.

### SOME EXAMPLES

Example A1. A network node 16 configured to communicate with a wireless device 22 (WD 22), the network node 16 configured to, and/or comprising a radio interface 62 and/or comprising processing circuitry 68 configured to:

receive an indication that the wireless device 22 is at least one of:
switching from a first bandwidth part, BWP, to a second BWP of a first secondary cell, SCell 18, if a SCell deactivation timer associated with the first SCell 18 has expired and a listen before talk, LBT, failure criterion has not been met for the second BWP; and
performing an LBT recovery procedure with a second SCell 18 different from the first SCell 18; and

the indication being associated with a LBT failure criterion being met for the first BWP.

Example A2. The network node 16 of Example A1, wherein the network node 16 and/or the radio interface 62 and/or the processing circuitry 68 is configured to:

receive an indication that the wireless device 22 has deactivated the first SCell if the LBT failure criterion is met for a plurality of BWP including the first BWP that are associated with the first SCell 18.

Example A3. The network node 16 of any one of Examples A1-A2, wherein the second SCell 18 is selected based on at least one of the following:

a random selection;

configuration of the wireless device 22;

a lowest channel occupancy among SCells 18;

a lowest LBT failure occurrence among SCells 18; and

respective SCell priority order.

Example A4. The network node 16 of any one of Examples A1-A3, wherein the network node 16 and/or the radio interface 62 and/or the processing circuitry 68 is further configured to receive an indication of the wireless device 22 attempting to perform a LBT recovery procedure with a third SCell 18.

Example B1. A method implemented in a network node 16, the network node 16 configured to communicate with a wireless device 22, the method comprising:

receiving an indication that the wireless device 22 is at least one of:
switching from a first bandwidth part, BWP, to a second BWP of a first secondary cell, SCell 18, if a SCell deactivation timer associated with the first SCell 18 has expired and a listen before talk, LBT, failure criterion has not been met for the second BWP; and
performing an LBT recovery procedure with a second SCell 18 different from the first SCell 18; and

the indication being associated with a LBT failure criterion being met for the first BWP.

Example B2. The method of Example B1, further comprising receiving an indication that the wireless device 22 has deactivated the first SCell 18 if the LBT failure criterion is met for a plurality of BWP including the first BWP that are associated with the first SCell 18.

Example B3. The method of any one of Examples B1-B2, wherein the second SCell 18 is selected based on at least one of the following:

a random selection;

configuration of the wireless device 22;

a lowest channel occupancy among SCells 18;

a lowest LBT failure occurrence among SCells 18; and

respective SCell priority order.

Example B4. The method of any one of Examples B1-B3, further comprising receiving an indication of the wireless device 22 attempting to perform a LBT recovery procedure with a third SCell 18.

Example C1. A wireless device 22 configured to communicate with a network node 18, the wireless device 22 configured to, and/or comprising a radio interface 62 and/or processing circuitry 68 configured to:

in response to determining a listen before talk, LBT, failure criterion has been met for a first bandwidth part, BWP, perform at least one of:
switch to second BWP of a first secondary cell, SCell 18, if a SCell deactivation timer associated with the first SCell 18 has expired and the LBT failure criterion has not been met for the second BWP; and
perform an LBT recovery procedure with a second SCell 18 different from the first SCell 18.

Example C2. The wireless device 22 of Example C1, wherein the wireless device 22 and/or the radio interface 62 and/or the processing circuitry 68 is configured to:

deactivate the first SCell 18 if the LBT failure criterion is met for a plurality of BWP including the first and second BWPs that are associated with the first SCell 18; and

trigger a report indicating the deactivation of the first SCell 18.

Example C3. The WD 22 of any one of Examples C1-C2, wherein the wireless device 22 and/or the radio interface 62 and/or the processing circuitry 68 is further configured to select the second SCell 18 based at on least one of the following:

a random selection;

configuration of the wireless device 22;

a lowest channel occupancy among SCells 18;

a lowest LBT failure occurrence among SCells 18; and

respective SCell priority order.

Example C4. The wireless device 22 of any one of Examples C1-C3, wherein the wireless device 22 and/or the radio interface 62 and/or the processing circuitry 68 is configured to:

trigger a timer associated with the LBT recovery procedure; and

upon expiration of the timer, initiate a LBT recovery procedure with a third SCell 18.

Example D1. A method implemented in a wireless device 22, the method comprising:

in response to determining a listen before talk, LBT, failure criterion has been met for a first bandwidth part, BWP, perform at least one of:
switching to second BWP of a first secondary cell, SCell 18, if a SCell deactivation timer associated with the first SCell 18 has expired and the LBT failure criterion has not been met for the second BWP; and
performing an LBT recovery procedure with a second SCell 18 different from the first SCell 18.

Example D2. The method of Example D1, further comprising:

deactivating the first SCell 18 if the LBT failure criterion is met for a plurality of BWP including the first and second BWPs that are associated with the first SCell 18; and

triggering a report indicating the deactivation of the first SCell 18.

Example D3. The method of any one of Examples D1-D2, further comprising selecting the second SCell 18 based on at least one of the following:

a random selection;

configuration of the wireless device 22;

a lowest channel occupancy among SCells 18;

a lowest LBT failure occurrence among SCells 18; and

respective SCell priority order.

Example D4. The wireless device 22 of any one of Examples D1-D4, further comprising:

triggering a timer associated with the LBT recovery procedure; and

upon expiration of the timer, initiating a LBT recovery procedure with a third SCell.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A wireless device, comprising:
processing circuitry configured to:
perform a listen before talk, LBT, recovery procedure based at least on one of expiration and triggering of a first timer, the first timer being associated with a LBT failure criterion that is met for at least a first bandwidth part, BWP, associated with a first secondary cell, SCell;
the LBT recovery procedure including one of:
switching to a second BWP associated with the first SCell for LBT recovery, the second BWP not meeting the LBT failure criterion; and
selecting a second SCell for LBT recovery.

2. The wireless device of claim 1, wherein the first timer is a SCell deactivation timer that is configured to deactivate the first SCell based on a determination that N BWPs associated with the first SCell meet the LBT failure criterion, N being a positive integer.

3. The wireless device of claim 2, wherein N corresponds to all the BWPs associated with the first SCell.

4. The wireless device of claim 1, wherein the first timer is configured by radio resource control, RRC, signaling for the first SCell in unlicensed operation.

5. The wireless device of claim 1, wherein the first timer is set to a predefined value based on radio resource control, RRC, signaling not providing a value for the first timer.

6. The wireless device of claim 1, wherein the LBT recovery procedure is performed while the first timer is running.

7. The wireless device of claim 6, wherein the second SCell is selected based on one of:
a random selection among a plurality of SCells including the second SCell;
a channel occupancy level associated with each of the plurality of SCells;
a lowest LBT failure occurrence metric associated with each of the plurality of SCells; and
a respective priority associated with each of the plurality of SCells.

8. The wireless device of claim 6, wherein the processing circuitry is further configured to:
trigger a second timer upon initiating the LBT recovery procedure, the second timer being configured to stop based on one of:
transmission of a recovery message; and
receive acknowledgement of the recovery message.

9. The wireless device of claim 8, wherein the processing circuitry is configured to switch from the first SCell in response to the second timer expiring.

10. The wireless device of claim 1, wherein the processing circuitry is further configured to stop the first timer based on one of:
transmission of a recovery message; and
receive acknowledgement of the recovery message.

11. The wireless device of claim 10, wherein the processing circuitry is configured to, after expiration of the first timer, autonomously one of:
switch to another BWP; and
deactivate the first SCell according to a same procedure as a procedure used when a SCell Activation/Deactivation medium access control, MAC, control element, CE, is received to deactivate an SCell.

12. The wireless device of claim 1, wherein the processing circuitry is further configured to cause transmission of a report message indicating LBT failures for the first SCell, the report message being transmitted on one of the second BWP and second SCell.

13. The wireless device of claim 12, wherein the report message includes one of:
channel occupancy information;
LBT statistics;
at least one radio quality indicator;
at least one service quality of service indicator;
buffer status report;
power headroom report; and
an indication of one of at least one other BWP and SCell that meets the LBT failure criterion.

14. A network node, comprising:
processing circuitry configured to:
receive signaling associated with a wireless device performing a listen before talk, LBT, recovery procedure, the LBT recovery procedure being based at least on one of expiration and triggering of a first timer, the first timer being associated with a LBT failure criterion that is met for at least a first bandwidth part, BWP associated with a first secondary cell, SCell, the LBT recovery procedure including one of:
the wireless device switching to a second BWP associated with the first SCell for LBT recovery, the second BWP not meeting the LBT failure criterion; and
the wireless device selecting a second SCell for LBT recovery; and
cause transmission of signaling based at least on the LBT recovery procedure.

15. The network node of claim 14, wherein the first timer is a SCell deactivation timer that is configured to cause the wireless device to deactivate the first SCell based on a determination that N BWPs associated with the first SCell meet the LBT failure criterion, N being a positive integer.

16. The network node of claim 15, wherein N corresponds to all the BWPs associated with the first SCell.

17. The network node of claim 14, wherein the processing circuitry is further configured to configure the first timer by radio resource control, RRC, signaling for the first SCell in unlicensed operation.

18. The network node of claim 14, wherein the RRC signaling is configured to set the first timer to a predefined value based on the RRC signaling not providing a value for the first timer.

19. The network node of claim 14, wherein the LBT recovery procedure is configured to be performed while the first timer is running.

20. The network node of claim 19, wherein the second SCell is configured to be selected based on one of:
a random selection among a plurality of SCells including the second SCell;
a channel occupancy level associated with each of the plurality of SCells;
a lowest LBT failure occurrence metric associated with each of the plurality of SCells; and
a respective priority associated with each of the plurality of SCells.

21. The network node of claim 19, wherein the processing circuitry is further configured to one of receive a recovery message and cause transmission of acknowledgment of the recovery message that is configured to stop a second timer that was initiated by the LBT recovery procedure.

22. The network node of claim 19, wherein the processing circuitry is further configured to one of receive a recovery message and cause transmission of acknowledgment of the recovery message that is configured to stop the first timer.

23. The network node of claim 14, wherein the processing circuitry is further configured to receive a report message indicating LBT failures for the first SCell, the report message being received on one of the second BWP and second SCell.

24. The network node of claim 23, wherein the report message includes one of:
channel occupancy information;
LBT statistics;
at least one radio quality indicator;
at least one service quality of service indicator;
buffer status report;
power headroom report; and
an indication of one of at least one other BWP and SCell that meets the LBT failure criterion.

25. A method implemented in a wireless device, the method comprising:
performing a listen before talk, LBT, recovery procedure based at least on one of expiration and triggering of a first timer, the first timer being associated with a LBT failure criterion that is met for at least a first bandwidth part, BWP, associated with a first secondary cell, SCell;
the LBT recovery procedure including one of:
switching to a second BWP associated with the first SCell for LBT recovery, the second BWP not meeting the LBT failure criterion; and
selecting a second SCell for LBT recovery.

26.-37. (canceled)

38. A method implemented by a network node, the method comprising:
receiving signaling associated with a wireless device is performing a listen before talk, LBT, recovery procedure, the LBT recovery procedure being based at least on one of expiration and triggering of a first timer, the first timer being associated with a LBT failure criterion that is met for at least a first bandwidth part, BWP associated with a first secondary cell, SCell, the LBT recovery procedure including one of:
the wireless device switching to a second BWP associated with the first SCell for LBT recovery, the second BWP not meeting the LBT failure criterion; and
the wireless device selecting a second SCell for LBT recovery; and
cause transmission of signaling based at least on the LBT recovery procedure.

39.-48. (canceled)
